(19) United States
(12) Patent Application Publication
(10) Pub. No.: US 2026/0070413 A1
(43) Pub. Date: Mar. 12, 2026

(54) LAMINATED PANE HAVING REFLECTIVE LAYER APPLIED IN CERTAIN REGIONS

(71) Applicant: SAINT-GOBAIN SEKURIT FRANCE, Thourotte (FR)

(72) Inventors: Jan HAGEN, HERZOGENRATH (DE); Michael MÜLLER, HERZOGENRATH (DE); Andreas GOMER, HERZOGENRATH (DE); Oliver GIER, HERZOGENRATH (DE)

(21) Appl. No.: 19/107,290

(22) PCT Filed: Aug. 25, 2023
(86) PCT No.: PCT/EP2023/073321

§ 371 Date: Feb. 27, 2025

(30) Foreign Application Priority Data
Aug. 30, 2022 (EP) 22192935.9

(51) Int. Cl. B60K 35/231; B32B 17/10; C03C 17/34

(52) U.S. Cl. CPC B60K 35/231; B32B 17/10036; B32B 17/10211; B32B 17/10348; C03C 17/3441; B32B 2307/7376; B32B 2605/00; B60K 2360/785; C03C 2217/213; C03C 2217/282; C03C 2217/734; C03C 2218/156

(57) ABSTRACT

A laminated pane includes an outer pane, a thermoplastic intermediate layer, an inner pane, a masking layer arranged in a region of the laminated pane, an adhesive layer, and a glass pane having an outer-side surface and an interior-side surface and a thickness of 20 μm to 500 μm. The thermoplastic intermediate layer is arranged between the outer and inner panes, the adhesive layer is arranged between the inner pane and the glass pane, at least one reflection layer for reflecting light is arranged on the outer-side surface of the glass pane and/or on the interior-side surface of the glass pane, and the glass pane is arranged in a region of the laminated pane which, when viewed perpendicularly through the laminated pane, lies entirely within the region in which the masking layer is arranged. The reflective layer contains of a dielectric layer, a silicon-based layer, or a carbide layer.

The invention relates to a laminated pane having a reflective layer applied in certain regions, a method for the production and use thereof, and to a projection assembly.

Modern automobiles are increasingly equipped with so-called head-up displays (HUD's). With a projector, typically in the region of the dashboard, images are projected onto the windshield, reflected there, and perceived by the driver as a virtual image behind the windshield. Thus, important information can be projected into the field of vision of the driver, for example, the current travel speed, navigation messages or warnings that the driver can perceive without having to turn his gaze away from the road. Head-up displays can accordingly contribute substantially to increasing traffic safety.

However, head-up displays often have the problem that the region of the windshield which is provided for reflection of the light projected by the projector has to have a high transparency of generally at least 70%. The reflected light of the projector is thus overlaid with light from the external environment, which, depending on the light conditions, can lead to a reduction in contrast of the virtual image and thus to a poorer visual perception for the driver. A sufficient visual perception of, in particular, safety-relevant information such as lane assistance, speed display or rotational speed of the motor should be ensured in all weather and light conditions. It would thus be desirable to have a projection assembly which is based on the head-up display technology in which no undesired secondary images occur and the arrangement of which is relatively easy to accomplish with good visibility with sufficient brightness and contrast of the displayed image information. In order to achieve this, it is necessary to increase the contrast in the reflection region of the windshield. The contrast increase can be achieved, for example, by the background of the reflection region being largely or completely opaque. However, such solutions require that a reflective layer is applied only in a locally limited region of the windshield.

The application of metallic coatings to glass panes is usually achieved by sputtering, in particular magnetron sputtering. During sputtering, atoms are released from a target by bombarding it with ions. By means of physical vapor deposition, the glass pane is coated with the atoms released from the target in an evacuated chamber. The atoms move, guided by electric fields, through the chamber towards the glass pane. They therefore move from the cathode, on which the target is arranged, towards the anode. Due to the arrangement of the glass pane between cathode and anode, a layer forms on the glass pane. In the case of magnetron sputtering, an additional magnetic field is arranged behind the cathode, which leads to faster layer growth and a denser, i.e., less porous, layer. Methods in which sputtering is used to coat glass panes are known, for example, from WO9900528 A1, DE10126868 C1 and WO2017198363 A1.

Magnetron sputtering is also suitable for coating glass panes because, unlike many other coating technologies, it can also be used when the glass pane is curved, as is the case with panes intended for the automotive sector, for example. A disadvantage of sputtering, however, is that without special precautions, it is not possible to selectively coat only certain surface regions, instead always the entire surface. The selective coating of only certain surface regions can be achieved, for example, by complex masking of the regions that are not to be coated. However, such masking can only be integrated into the industrial series production of coated glass panes with considerable effort and is associated with relatively high costs.

Cold gas spraying is also a suitable method for coating glass panes and is a coating method generally known to a person skilled in the art, with which a powder is applied to a carrier at very high speed. Methods for coating by means of cold gas spraying are known, for example, from WO2010/003396 A1, EP3845685 A1 and EP2902530 A1.

From WO2022161894 A1, a laminated pane with a holographic-optical element applied to the interior-side surface of the inner pane is known as a light-directing device for directing light from a projector, wherein the light-directing device is arranged overlapping a masking strip, in order to allow a high contrast.

The object of the present invention is to provide an improved laminated pane having a reflective layer applied in certain regions. In particular, the laminated pane should be easy to manufacture.

The object of the present invention is achieved according to the invention by a laminated pane according to Claim 1. Preferred embodiments are apparent from the dependent claims.

The laminated pane according to the invention comprises an outer pane, a thermoplastic intermediate layer, at least one masking layer, an inner pane, an adhesive layer and a glass pane. The thermoplastic intermediate layer is arranged between the outer pane and the inner pane, and the adhesive layer is arranged between the inner pane and the glass pane. According to the invention, the at least one masking layer is arranged in a region of the laminated pane and the glass pane is arranged in a region of the laminated pane which, when viewed perpendicularly through the laminated pane, lies entirely within the region in which the at least one masking layer is arranged.

The laminated pane is provided to separate the interior from the external environment in a window opening of a vehicle. Within the meaning of the invention, the term “inner pane” refers to the pane of the laminated pane facing the vehicle interior. Outer pane means the pane facing the external environment.

The laminated pane has in particular an upper edge and a lower edge and two side edges extending between them. Upper edge means the edge intended to point upwards in the installed position. Lower edge means the edge intended to point downward in the installed position. In the case of a windshield, the upper edge is often also referred to as the roof edge and the lower edge is referred to as the motor edge.

The outer pane, the inner pane and the glass pane in each case have an outer-side and an interior-side surface and a circumferential side edge extending between them. In the sense of the invention, the outer-side surface means the main surface which is intended to face the external environment when installed. In the sense of the invention, the interior-side surface means the main surface which is intended to face the interior when installed. The interior-side surface of the outer pane and the outer-side surface of the inner pane face one another and are connected to one another by the thermoplastic intermediate layer.

The outer-side surface of the outer pane is designated as side I. The interior-side surface of the outer pane is designated as side II. The outer-side surface of the inner pane is designated as side III. The interior-side surface of the inner pane is designated as side IV. The outer-side surface of the glass pane is designated as side V. The interior-side surface of the glass pane is designated as side VI.

The interior-side surface of the outer pane and the outer-side surface of the inner pane face one another. In one embodiment, the inner pane is arranged between the outer pane and the glass pane, wherein the interior-side surface of the inner pane and the outer-side surface of the glass pane face one another.

In a further embodiment, the glass pane is arranged between the outer pane and the inner pane, wherein the interior-side surface of the glass pane and the outer-side surface of the inner pane face one another.

According to the invention, the glass pane is very thin and has a thickness of 20 μm (micrometers) to 500 μm. The glass pane is therefore made of ultra-thin glass. Such a pane of ultra-thin glass is flexible and can be advantageously adapted to the curvature of a pane.

In addition, according to the invention at least one reflective layer for reflecting light is arranged on the outer-side surface of the glass pane and/or on the interior-side surface of the glass pane. Thus, a single reflective layer can be provided which is arranged on the outer-side surface of the glass pane or on the interior-side surface of the glass pane. Alternatively, two reflective layers can be provided which are arranged on the outer-side surface of the glass pane and on the interior-side surface of the glass pane. The outer-side surface and/or the interior-side surface of the glass pane is advantageously coated with the reflective layer, i.e., the reflective layer is arranged as a coating on the outer-side surface and/or the interior-side surface of the glass pane.

According to the invention, the at least one reflective layer, when the laminated pane is installed in a vehicle, is at a smaller distance from the vehicle interior than at least one masking layer, so that the imaging unit of a projection assembly arranged in the vehicle interior has a direct view of the reflective layer and the reflective layer can reflect light emitted by the imaging unit. It is also possible that an additional masking layer is arranged closer to the vehicle interior than the reflective layer. In order to ensure a direct view of the reflective layer from the imaging unit in this case, this additional masking layer has one or more openings, so that the light from the imaging unit is reflected by the reflective layer and can be seen by a viewer in the vehicle interior.

Due to the fact that the glass pane is arranged in a region of the laminated pane which, when viewed perpendicularly through the laminated pane, lies completely within the region in which at least one masking layer is arranged, the reflective layer arranged on the glass pane is also arranged in a region which, in a perpendicular view through the laminated pane, lies completely within the region in which the masking layer is arranged. The reflective layer is therefore arranged in a perpendicular view through the laminated pane or in an orthogonal projection through the laminated pane so as to cover or overlap with the masking layer. The reflective layer thus does not have a portion which does not cover the masking layer, i.e., the reflective layer is formed only where it is in front of the masking layer when viewing the inside of the laminated pane. This ensures high contrast and brightness and thus good recognizability of the virtual image reflected by the reflective layer.

In a preferred embodiment of the laminated pane according to the invention, the glass pane has a thickness of 50 μm to 300 μm, preferably of 50 μm to 100 μm, for example 70 μm.

As described above, the reflective layer is a reflective layer for reflecting light. The reflective layer is preferably light-impermeable or partially transparent, which within the meaning of the invention means that it has an average transmission (according to ISO 9050:2003) in the visible spectral range of preferably at most 80%, particularly preferably at most 50% and in particular less than 10%. The reflective layer preferably reflects at least 10%, particularly preferably at least 50%, and very particularly preferably at least 80% and in particular at least 90% of the light impinging upon the reflective layer. The reflective layer preferably reflects p-polarized and s-polarized light in equal proportions, but it can also reflect p-polarized light and s-polarized light to different degrees. In one embodiment, the light reflected by the reflective layer predominantly comprises p-polarized light, so that the virtual image is clearly visible even when using s-polarizing sunglasses.

The light reflected by the reflective layer is preferably visible light, i.e., light in a wavelength range of approximately 380 nm to 780 nm. The reflective layer preferably has a high and uniform reflectance (via different irradiation angles) to p-polarized and/or s-polarized radiation, so that a strong and color-neutral image presentation is ensured.

The indication of the polarization direction refers to the plane of incidence of the radiation on the composite pane. P-polarized radiation refers to a radiation the electric field of which oscillates in the plane of incidence. S-polarized radiation refers to a radiation the electric field of which oscillates perpendicular to the plane of incidence. The plane of incidence is spanned by the incident vector and the surface normal of the composite pane in the geometric center of the irradiated region.

In other words, the polarization, i.e., in particular, the proportion of p- and s-polarized radiation, is determined at a point of the region irradiated by the image display device, preferably in the geometric center of the irradiated region. Since laminated panes can be curved (for example, when configured as a windshield), which has effects upon the plane of incidence of the radiation, polarization components slightly deviating therefrom can occur in the other regions, which is unavoidable for physical reasons.

In principle, the reflective layer can be constructed in one or more layers, i.e., it can consist of a single layer made of a single material or of a plurality of layers of different materials (i.e., a plurality of individual layers made of different materials). If the reflective layer consists of a plurality of layers, it can also be regarded as a multilayer coating or a thin-film stack or a sequence of thin individual layers.

The reflective layer is designed to be suitable for reflecting light, preferably visible light. In particular, the layer thickness and refractive index of the reflective layer are selected such that constructive interference occurs at the reflective layer when the incident light is reflected. The light generated by the imaging unit of a projection assembly and directed onto the reflective layer generally has not just a single wavelength, but a wavelength range with many different wavelengths. Likewise, the incident light will not only be incident at a single angle of incidence, but at a range of many different angles of incidence. It is understood that as broad-spectrum a reflection as possible at different angles of incidence is advantageous, although in practice a satisfactory compromise must be found. A person skilled in the art is familiar with reflection on thin layers, and suitable conditions can be determined on the basis of simple experiments.

According to a first alternative of the invention, the reflective layer is a dielectric layer. According to a second alternative of the invention, the reflective layer is a silicon-based layer. According to a third alternative of the invention, the reflective layer is a carbide layer. With these reflective layers, broad-spectrum reflections having high reflectivity can be achieved based on constructive interference. In any case, the reflective layer is not a metallic layer, i.e., not a layer that contains or consists of metal. Furthermore, the reflective layer is not a holographic optical element, i.e., light is reflected by the reflective layer and not diffracted. Accordingly, the reflective layer configured in the form of a dielectric layer according to the first alternative of the invention is not a polymer layer, which is a component of a holographic optical element.

In the first alternative of the invention, the reflective layer is a dielectric layer and contains or consists of one or more materials that are electrically non-conductive or weakly conductive, wherein existing charge carriers are not freely mobile (insulators). The dielectric layer can be a single-ply layer or a multi-ply layer, in particular a two-ply layer.

In an advantageous embodiment of the invention, the dielectric layer is a two-ply layer (bilayer), wherein the two-ply layer consists of a first layer and a second layer, wherein the first layer contains or consists of an optically high-refractive material (with a high refractive index), and the second layer contains or consists of an optically low-refractive material (with a low refractive index). The terms “high-refractive index” and “low-refractive index” are common in the field. To avoid absolute specifications, the term “high refractive index” can also be interpreted as “higher refractive index” and the term “low refractive index” can also be interpreted as “lower refractive index,” wherein the relative specifications refer to the refractive indices of the two layers.

The particular advantage of the two-ply reflective layer lies in the possibility of simpler production using a PVD method, in particular sputtering, since experience has shown that single-ply reflective layers with the desired layer thicknesses and refractive indices are more difficult to produce. In addition, two-ply coatings offer more degrees of freedom with regard to varying the layer thicknesses and refractive indices of the individual layers, in order to achieve as broad-spectrum a reflection as possible at different angles of incidence. For this purpose, the two layers of the two-ply reflective layer preferably have different thicknesses and/or different refractive indices.

Advantageously, the first layer with an optically high-refractive material has a refractive index in the range from 1.9 to 2.5 and/or the second layer with an optically low-refractive material has a refractive index in the range from 1.3 to 1.6. Particularly advantageously, the first layer with an optically high-refractive material has a thickness in the range of 50 to 100 nm, preferably 70 to 90 nm, and/or the second layer with an optically low-refractive material has a thickness in the range of 100 to 200 nm, preferably 110 to 150 nm. As experiments by the inventors have shown, these parameters allow light to be reflected with a particularly high bandwidth at different angles of incidence with high reflectivity. For example, the two-ply reflective layer consists of TiOₓ/SiOₓ (titanium oxide/silicon oxide), where TiOₓ has a refractive index n=2.45 and SiOₓ a refractive index n=1.45.

In the context of the present invention, refractive indices are in all cases specified in relation to a wavelength of 550 nm. Methods for determining refractive indices are known to the person skilled in the art. The refractive indices specified within the scope of the invention can be determined, for example, by ellipsometry, wherein commercially available ellipsometers can be used.

The first layer with an optically high-refractive material is located between the glass pane and the second layer with an optically low-refractive material, i.e., the first layer with an optically high-refractive material is arranged closer to the glass pane than the second layer with an optically low-refractive material.

Preferably, when the reflective layer is designed as a two-ply reflective layer with a first layer with an optically high-refractive material and a second layer with an optically low-refractive material, the coated glass pane is arranged on the interior-side surface (side IV) of the inner pane, wherein the reflective layer is located on the interior-side surface (side VI) of the glass pane. With such an arrangement, the incident light can be reflected with a high bandwidth and particularly high reflectivity.

In the second alternative of the invention, the reflective layer is a silicon-based layer, i.e., the reflective layer contains or consists of silicon, wherein silicon is contained in the form of undoped silicon, doped silicon or a silicon compound. The silicon-based layer can be a single-ply layer or a multi-ply layer, in particular a two-ply layer.

In an advantageous embodiment of the invention, the silicon-based layer is a single-ply layer, i.e., consists of a single layer of the same material. Advantageously, the silicon-based layer contains or consists of undoped silicon. Alternatively, the silicon-based layer contains doped silicon which is doped with one or more dopants, wherein the dopant is preferably selected from boron (B), aluminum (Al) and zirconium (Zr), or consists thereof. As the inventors were able to show, such a reflective layer can reflect incident light over a broad spectrum with high reflectivity.

In an advantageous embodiment of the invention, the silicon-based layer is a two-ply reflective layer (bilayer), wherein the two-ply reflective layer consists of a first layer and a second layer, wherein the first layer contains or consists of silicon doped with one or more dopants, wherein the dopant is selected in particular from boron (B), aluminum (Al) and zirconium (Zr), and the second layer contains or consists of a silicon compound. As the inventors were able to show, a high reflectivity can be achieved over a broad spectrum with such a reflective layer. For example, the two-ply reflective layer consists of Si(B)/SiAlNₓ, Si(ZrAl)/SiAlOₓ, or Si(B)/SiAlOₓ. The dopant is in each case indicated in brackets. The first layer is located between the glass pane and the second layer, i.e., the first layer is closer to the glass pane than the second layer.

Advantageously, the silicon-based layer has a thickness in the range of 10 to 100 nm, preferably 20 to 50 nm.

In a particular embodiment of the invention, a single-ply or double-ply reflective layer is arranged on the outer-side surface (side V) and the interior-side surface (side VI) of the glass pane. It is conceivable to add a further layer of SiO₂ to the reflective layer on the interior-side surface (side VI) of the glass pane, in order to further increase the reflectivity. The layer of SiO₂ preferably has a thickness in the range of 50 to 150 nm, more preferably in the range of 70 to 130 nm.

In the third alternative of the invention, the reflective layer is a carbide layer, i.e., the reflective layer contains or consists of a carbide compound. In an advantageous embodiment of the invention, the carbide layer is a single-ply layer, i.e., consists of a single layer with the same substance. Advantageously, the carbide layer is a single-ply layer and has a layer thickness in the range of 10 to 100 nm, preferably 30 to 80 nm. Advantageously, the carbide layer contains or consists of TiC or ZrC. As the inventors were able to show, a high reflectivity can be achieved over a broad spectrum with such a reflective layer.

Unless otherwise indicated, the specification of layer thicknesses or thicknesses refers to the geometric thickness of a layer. The methods for determining layer thicknesses are known to a person skilled in the art. The layer thicknesses specified within the scope of the invention can be determined, for example, by ellipsometry, wherein commercially available ellipsometers can be used.

As described above, in the laminated pane according to the invention at least one masking layer is arranged in a region of the laminated pane. The masking layer is preferably arranged in an edge region of the laminated pane, which is typically adjacent to the pane edge of the pane. The great advantage of this arrangement is obtained when using the laminated pane in a vehicle as a windshield, since the masking layer lies outside the main viewing region of the driver when arranged in an edge region.

The masking layer is preferably arranged at least along the lower edge and adjacent to the lower edge. This results in a rectangular opaque strip, which is arranged along the lower edge, when looking onto the laminated pane.

In a particular embodiment of the laminated pane according to the invention, the masking layer is designed to run circumferentially in a frame-like manner. In a portion in which the glass pane and thus also the reflective layer applied thereon is arranged overlapping the masking layer, the frame-like masking layer is preferably provided with a widening, i.e., it has a greater width (dimension perpendicular to the extension) than in other portions. In this way, the masking layer can be adapted in a suitable manner to the dimensions of the glass pane with the reflective layer applied thereto. In a preferred embodiment, the masking layer is thus designed to run circumferentially in a frame-like manner and, in particular in a portion which overlaps the glass pane, has a greater width than in portions different therefrom.

The glass pane with the reflective layer applied thereto preferably has substantially the shape of a rectangle which extends between the two side edges in a region near the lower edge. Particularly preferably, the edges of the glass pane do not reach the side edges and the lower edge, but instead are, for example, 2 cm to 5 cm distant from them.

The opaque cover layer within the meaning of the invention is a layer that prevents the view through the laminated pane. In this case, at most 5%, preferably at most 2%, particularly preferably at most 1%, in particular at most 0.1%, of the light of the visible spectrum is transmitted through the masking layer. The masking layer is thus an opaque masking layer, preferably a black masking layer.

The masking layer is preferably a coating made up of one or more layers. Alternatively, the masking layer can also be a colored region of the thermoplastic intermediate layer. According to a preferred embodiment of the laminated pane, the masking layer consists of a single layer. This has the advantage of a particularly simple and cost-effective manufacture of the laminated pane because only a single layer has to be formed for the masking layer. The masking layer is in particular an opaque masking print made of a dark, preferably black, enamel.

Advantageously, the at least one masking layer is formed as an opaque masking print arranged on the interior-side surface (side II) of the outer pane, in particular made of a dark, preferably black, enamel. Alternatively or in addition, the masking layer is designed as an opaque masking print arranged on the outer-side surface (side III) of the inner pane, in particular made of a dark, preferably black, enamel. In particular, a first opaque masking print can be arranged on the interior side surface (side II) of the outer pane and a second opaque masking print on the outer-side surface (side III) of the inner pane.

If the glass pane coated with at least one reflective layer is arranged on the outer-side surface (side III) of the inner pane, there is a masking layer between the outer pane and the coated glass pane. If an additional masking layer (e.g., opaque masking print) is arranged closer to the inner pane, this masking layer is provided with one or more openings, in order to ensure a clear view of the reflective layer from the interior.

In an alternative embodiment, the masking layer is designed as an opaquely colored region of the thermoplastic intermediate layer. In one embodiment, the thermoplastic intermediate layer is formed in one piece and is opaquely colored in a region.

An opaque masking layer formed as an opaquely colored region of the thermoplastic intermediate layer can also be realized by using a thermoplastic intermediate layer composed of an opaque thermoplastic film and a transparent thermoplastic film. The opaque thermoplastic film and transparent thermoplastic film are preferably arranged offset from one another, so that the two films are not overlapping when viewed through the laminated pane. The transparent and the opaque film consist of the same plastics or preferably contain the same plastics. The materials on the basis of which the opaque film and the transparent film can be formed are those which are also described for the thermoplastic intermediate layer. The opaque film is preferably a colored film which can have different colors, in particular black.

The laminated pane according to the invention can in particular have an opaque masking print arranged on the interior-side surface of the inner pane, in particular at least in the region in which the glass pane is arranged. Such a masking print on the interior-side surface of the inner pane improves the adhesion properties of the surface relative to an adhesive layer. The opaque masking print is preferably designed in the shape of a frame.

In a preferred embodiment of the laminated pane according to the invention, a reflective layer for reflecting light is arranged on the interior-side surface of the glass pane and a protective layer is arranged on this reflective layer.

In a further preferred embodiment of the laminated pane according to the invention, a reflective layer for reflecting light is arranged both on the interior-side surface of the glass pane and on the outer-side surface of the glass pane, and a protective layer is arranged on the reflective layer, which is arranged on the interior-side surface of the glass pane. No protective layer is necessary for the reflective layer arranged on the outer-side surface of the glass pane, since this reflective layer is connected to the inner pane via the adhesive layer and is thus protected. Optionally, a protective layer can also be arranged on the reflective layer arranged on the outer-side surface of the glass pane.

The protective layer is preferably transparent and applied in a planar manner, in particular congruently, on the reflective layer. The protective layer is preferably a polymer based on polyacrylates, polyoximes, alkyd resins, polyurethanes or mixtures thereof. The protective layer preferably has a thickness of 50 nm to 10 μm and particularly preferably of 100 nm to 5 μm. In particular, the protective layer does not consist of a glass material, i.e., the protective layer is not a glass pane.

The protective layer protects the reflective layer from mechanical damage, such as scratches. It can also serve to increase the durability of the reflective layer.

In a particularly preferred embodiment of the invention, the protective layer is a layer that is easy to clean and/or an “anti-fingerprint” layer. For the purposes of the invention, a layer that is easy to clean means that dirt in the form of, for example, fingerprints, grease spots and dirt particles on the protective layer can be removed from the protective layer by using a cloth and preferably a microfiber cloth. Grease-dissolving or abrasive cleaning agents and solvents, for example based on alcohols, are therefore largely avoided for the cleaning of the protective layer. For the purposes of the invention, an anti-fingerprint layer means a layer with which fingerprints that adhere to the protective layer are hardly or not at all perceptible visually. The term “fingerprints” refers in particular to the grease-containing components of a human finger that remain on a surface when a surface is touched and can be unaesthetic.

The adhesive layer is preferably a thermoplastic layer or an optical clear adhesive (OCA). Suitable optical clear adhesives (OCA) are known to a person skilled in the art. The adhesive layer formed as a thermoplastic layer comprises at least one thermoplastic polymer, preferably ethylene vinyl acetate (EVA), polyvinyl butyral (PVB) or polyurethane (PU), or mixtures, or copolymers, or derivatives thereof, particularly preferably PVB. The thermoplastic layer is typically formed from a thermoplastic film (joining film). The thickness of the thermoplastic layer is preferably from 0.2 mm to 2 mm, particularly preferably from 0.3 mm to 1 mm, for example 760 μm. The thermoplastic polymer layer can be formed by a single film or also by more than one film. The glass pane can be firmly connected to the inner pane by lamination, for example.

The laminated pane is preferably curved in one or more spatial directions, as is usual for motor vehicle panes, wherein the typical radii of curvature are in a range of approximately 10 cm to approximately 40 m. However, the laminated pane can also be flat, for example if it is provided as a pane for buses, trains or tractors.

The thermoplastic intermediate layer, via which the outer pane is joined to the inner pane, comprises at least one thermoplastic polymer, preferably ethylene vinyl acetate (EVA), polyvinyl butyral (PVB) or polyurethane (PU), or mixtures, or copolymers or derivatives thereof, particularly preferably PVB. The thermoplastic intermediate layer is typically formed from a thermoplastic film (joining film). The thickness of the thermoplastic intermediate layer is preferably from 0.2 mm to 2 mm, particularly preferably from 0.3 mm to 1 mm, for example 760 μm. The thermoplastic intermediate layer can be formed by a single film or also by more than one film. The thermoplastic intermediate layer can also be a film with functional properties, for example a film with acoustic damping properties.

The outer pane and the inner pane preferably contain or consist of glass, particularly preferably flat glass, float glass, quartz glass, borosilicate glass, soda-lime glass, alumino silicate glass, or clear plastics, preferably rigid clear plastics, in particular polyethylene, polypropylene, polycarbonate, polymethyl methacrylate, polystyrene, polyamide, polyester, polyvinyl chloride, and/or mixtures thereof.

The outer pane and the inner pane can be clear and colorless, but also tinted or colored. In a preferred embodiment, the total transmission through the windshield is greater than 70% in the main see-through region (light type A). The term total transmission relates to the method defined by ECE-R 43, Annex 3, § 9.1 for testing the light transmission of motor vehicle panes. Independently of one another, the outer pane and the inner panes can be not prestressed, partially prestressed or prestressed. If at least one of the panes is to be prestressed, this can be thermal or chemical prestressing.

The thickness of the outer pane and of the inner pane can vary widely and accordingly be adapted to the requirements in the individual case. The outer pane and the inner pane preferably have thicknesses of 0.5 mm to 5 mm, particularly preferably of 1 mm to 3 mm, very particularly preferably of 1.6 mm to 2.1 mm. For example, the outer pane has a thickness of 2.1 mm, and the inner pane a thickness of 1.6 mm. However, the outer pane or, in particular, the inner pane can also be a thin glass with a thickness of 0.55 mm, for example.

The glass pane preferably contains or consists of alumino-silicate glass, borosilicate glass, alumino-borosilicate glass. The glass pane can be tempered, partially tempered or non-tempered.

The laminated pane according to the invention can comprise one or more additional intermediate layers, in particular functional intermediate layers. An additional intermediate layer can be, in particular, an intermediate layer with acoustically damping properties, an intermediate layer reflecting infrared radiation, an intermediate layer absorbing infrared radiation, an intermediate layer absorbing UV radiation, a layer that is colored at least in portions and/or an intermediate layer that is tinted at least in portions. If there is a plurality of additional intermediate layers, they can also have different functions.

The invention also relates to a projection assembly, which comprises a laminated pane according to the invention and an imaging unit directed onto the reflective layer.

Also according to the invention, therefore, is a projection assembly, which comprises:
a laminated pane comprising an outer pane with an outer-side surface and an interior-side surface, a thermoplastic intermediate layer, an inner pane with an outer-side surface and an interior-side surface, at least one masking layer arranged in a region of the laminated pane between the outer pane and the inner pane, an adhesive layer and a glass pane with an outer-side surface and an interior-side surface and a thickness of 20 μm to 500 μm,
wherein the thermoplastic intermediate layer is arranged between the outer pane and the inner pane, the adhesive layer is arranged between the inner pane and the glass pane, a reflective layer for reflecting light is arranged on the outer-side surface of the glass pane and/or on the interior-side surface of the glass pane,
and wherein the glass pane is arranged in a region of the laminated pane which, when viewed perpendicularly through the laminated pane, lies completely within the region in which the masking layer is arranged,
and an imaging unit directed at the reflective layer.

In particular, the combination of the reflective layer with the masking layer that is behind from the perspective of a vehicle occupant brings about good visibility of the image in a projection assembly according to the invention, even in the case of external solar radiation and when attenuated-light imaging units are used. Even under these circumstances, the image generated by the imaging unit appears bright and can be seen perfectly. This enables a reduction in the power of the imaging unit and thus a reduced energy consumption.

From the viewpoint of a vehicle occupant, the reflective layer is arranged spatially in front of the masking layer when viewed through the inner pane. As a result, the region of the laminated pane in which the reflective layer is arranged appears opaque. The expression “when viewed through the laminated pane” means viewing through the laminated pane starting from the interior-side surface of the laminated pane. The expression “spatially in front of,” as used in the present invention, means that the reflective layer is arranged spatially further away from the outer-side surface of the outer pane than the masking layer. Preferably, the masking layer is widened at least in the region which overlaps with the reflective layer and in which the laminated pane is used for displaying images. This means that when viewed perpendicular to the closest portion of the peripheral edge of the laminated pane, the masking layer in this region has a greater width than in other portions. In this way, the masking layer can be adapted to the dimensions of the reflective layer.

The imaging unit of the projection assembly emits light and is arranged in the vicinity of the interior-side surface of the inner pane such that the imaging unit irradiates this surface, wherein the light is reflected by the reflective layer of the laminated pane. The reflective layer preferably reflects at least 10%, particularly preferably at least 50%, very particularly preferably at least 80% and in particular at least 90% of the light striking the reflective layer in a wavelength range of 400 nm to 700 nm and at angles of incidence of 55° to 80°. This is advantageous in order to achieve the greatest possible brightness of an image emitted by the imaging unit and reflected on the reflective layer.

The imaging unit serves to emit an image and can thus also be referred to as a projector, display device or image display device. A display or other device known to a person skilled in the art, for example, can be used as the imaging unit. The imaging unit is preferably a display, particularly preferably an LCD display, LED display, OLED display or electroluminescent display, in particular an LCD display. Displays have a low installation height and are thus simply integrated into the dashboard of a vehicle in a space-saving manner. Moreover, displays can be operated in a significantly more energy-saving manner than other imaging units. The comparatively lower brightness of displays is completely sufficient here in the combination according to the invention of the reflective layer and the mask layer located behind it. The radiation of the imaging unit preferably impinges in the region of the reflective layer at an incidence angle of 55° to 80°, preferably of 62° to 77° on the laminated pane. The incidence angle is the angle between the incidence vector of the radiation of the image display device and the surface normal in the geometric center of the reflective layer.

Due to the fact that the reflective layer is arranged on the outer-side surface and/or the interior-side surface of a glass pane with a thickness of 20 μm to 500 μm, which is glued to the interior-side surface of the inner pane according to an embodiment of the invention, the occurrence of a disturbing ghost image is avoided.

In a projection assembly with a reflective layer applied to the interior-side surface of the glass pane, the desired virtual image is created by reflection from the reflective layer and no ghost image occurs.

In a projection assembly with a reflective layer applied to the outer-side surface of the glass pane, the desired virtual image is generated by reflection from the reflective layer and, in addition, a second virtual image, the so-called ghost image, is generated by reflection from the interior-side surface of the glass pane.

With a projection assembly with a reflective layer applied to the outer-side surface of the glass pane and a reflective layer applied to the interior-side surface of the glass pane, a first virtual image is generated by reflection on the reflective layer applied to the outer-side surface of the glass pane and in addition a second virtual image is generated on the reflective layer applied to the interior-side surface of the glass pane.

However, with the small thicknesses for the glass pane according to the invention, the spatial offset between the first virtual image and the ghost image or between the first virtual image and the second virtual image is sufficiently small so as not to be disturbing. The effect is based on the typical angular visual acuity of the human eye: the thin glass pane according to the invention leads to an offset between the first virtual image and the ghost image or between the first virtual image and the second virtual image, which can no longer be resolved by the human eye.

The preferred designs of the laminated pane according to the invention described above also correspondingly apply to the projection arrangement according to the invention and vice versa.

According to the invention, there is a method for producing a laminated pane according to the invention comprising:
a) producing a composite of an outer pane with an outer-side surface and an interior-side surface, a thermoplastic intermediate layer and an inner pane with an outer-side surface and an interior-side surface, wherein the thermoplastic intermediate layer is arranged between the outer pane and the inner pane and at least one masking layer is arranged in a region between the outer pane and the inner pane;
b) providing a glass pane with an outer-side surface and an interior-side surface, wherein a reflective layer for reflecting light is arranged on the outer-side surface of the glass pane and/or on the interior-side surface of the glass pane;
c) joining the glass pane to the inner pane via an adhesive layer to form a laminated pane, such that the glass pane is arranged in a region of the laminated pane which, when viewed perpendicularly through the laminated pane, lies entirely within the region in which the masking layer is arranged.

Steps a), b) and c) can be carried out in the order given, simultaneously or in any desired order. In particular, step c) can carried out before or after step a). Step a) is carried out after step c), if the coated glass pane is applied to the outer-side surface (side III) of the inner pane. Step c) can be carried out after step a) if the coated glass pane is applied to the interior-side surface (side IV) of the inner pane.

As explained above, the glass pane is arranged in a region of the laminated pane which, when viewed perpendicularly through the laminated pane, lies completely within the region in which the masking layer is arranged. Thus, the external dimensions of the glass pane are smaller than the outer pane and the inner pane of the laminated pane. The provision of the glass pane in step b) can be carried out, for example, by applying a reflective layer over the entire surface of the interior-side surface and/or the outer-side surface of an uncoated glass pane, which is larger than desired in terms of external dimensions, i.e., width and length, and then cutting out a portion having the desired dimensions from such a coated glass pane, for example by means of a laser cutting method. A reflective layer can be selectively arranged in a region of the laminated pane via the glass pane provided with the reflective layer. The provision of the glass pane in step b) can additionally comprise the application of a protective layer to the reflective layer applied to the interior-side surface and/or the outer-side surface. The protective layer is preferably applied to the reflective layer by means of spraying, for example with a pressure atomizer.

If the laminated pane is to be curved, a curved outer pane and a curved inner pane are inserted in step a). The glass pane with the reflective layer is flexible due to the small thickness of the glass pane and adapts to the curved inner pane in step c). This is an advantage of the method according to the invention. With the method according to the invention, the coating with the reflective layer is carried out on a planar substrate.

The production of a composite in step a) or in step c) can be carried out by means of lamination methods familiar to a person skilled in the art.

When providing the glass pane in step b), the reflective layer can be applied by means of generally known coating methods, such as magnetron sputtering or cold gas spraying.

The preferred embodiments of the laminated pane according to the invention described above also correspondingly apply to the method according to the invention for producing a laminated pane according to the invention.

The invention also relates to the use of a laminated pane according to the invention as a vehicle pane in a means of transport for traffic on land, in the air or on water, in particular in motor vehicles and in particular as a windshield for a head-up display.

The various embodiments of the invention can be implemented individually or in any combinations. In particular, the features mentioned above can be used not only in the specified combinations, but also in other combinations or alone without departing from the scope of the present invention.

The invention is explained in more detail below with reference to exemplary embodiments, wherein reference is made to the accompanying figures. In a simplified, not-to-scale representation:

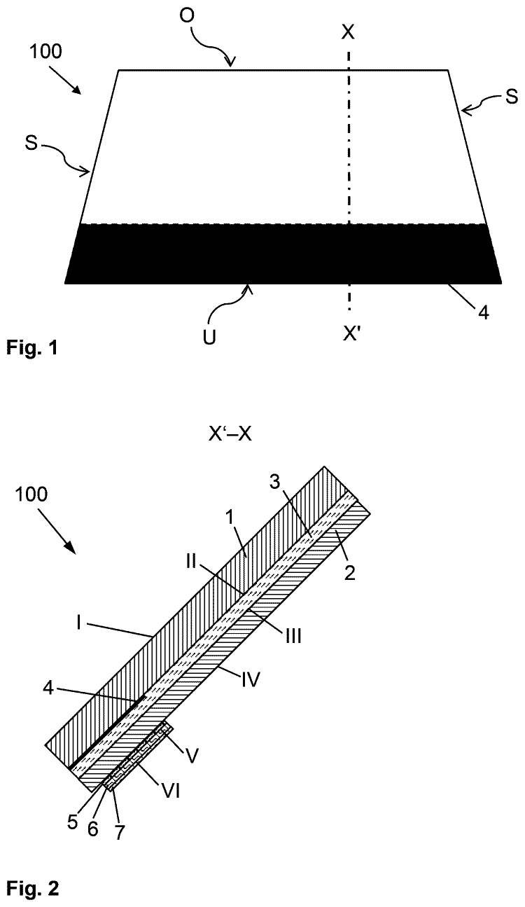

FIG. 1 is a plan view of an embodiment of the laminated pane according to the invention,

FIG. 2 shows a cross section through the embodiment shown in FIG. 1,

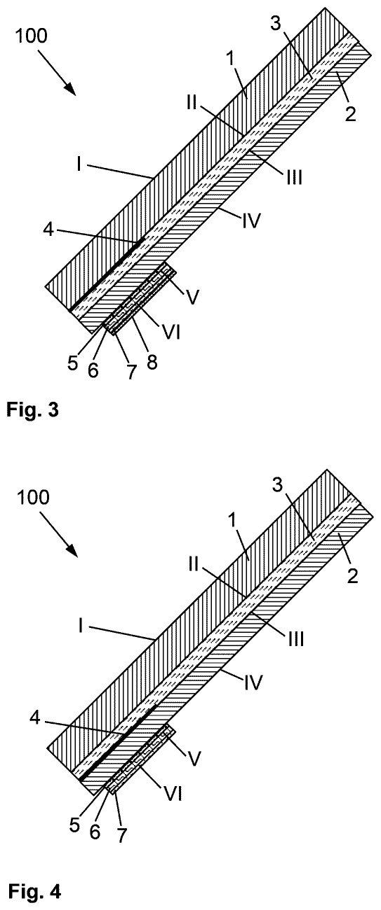

FIG. 3 shows a cross section through a further embodiment of the laminated pane according to the invention,

FIG. 4 shows a cross section through a further embodiment of the laminated pane according to the invention,

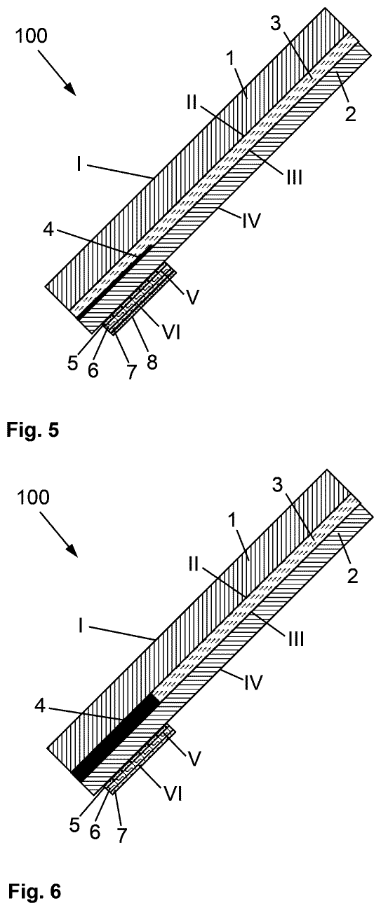

FIG. 5 shows a cross section through a further embodiment of the laminated pane according to the invention,

FIG. 6 shows a cross section through a further embodiment of the laminated pane according to the invention,

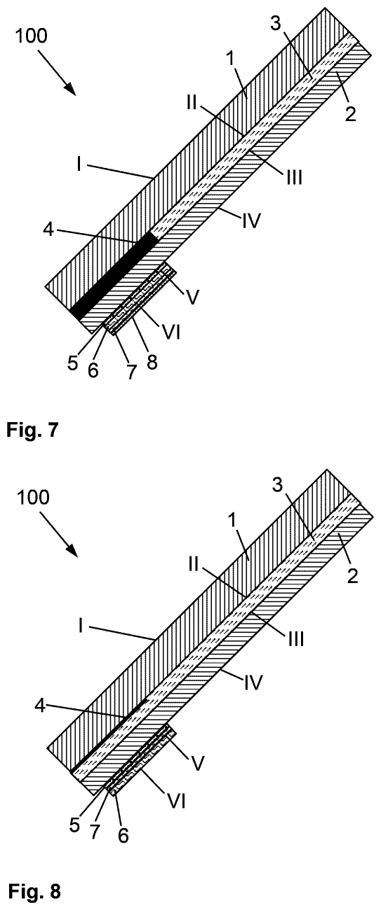

FIG. 7 shows a cross section through a further embodiment of the laminated pane according to the invention,

FIG. 8 shows a cross section through a further embodiment of the laminated pane according to the invention,

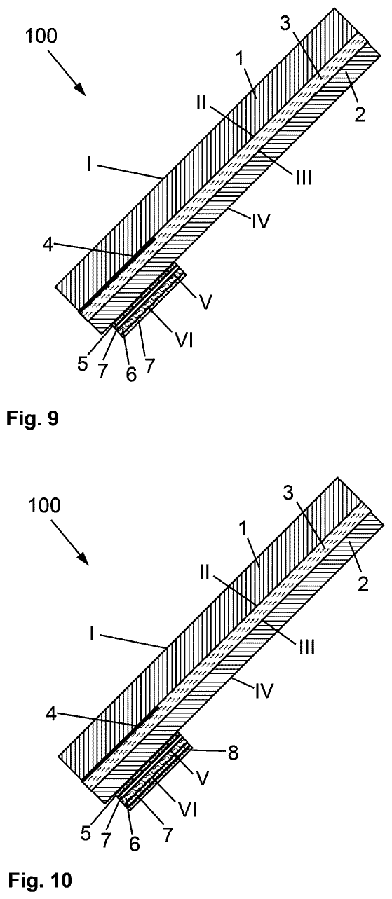

FIG. 9 shows a cross section through a further embodiment of the laminated pane according to the invention,

FIG. 10 shows a cross section through a further embodiment of the laminated pane according to the invention,

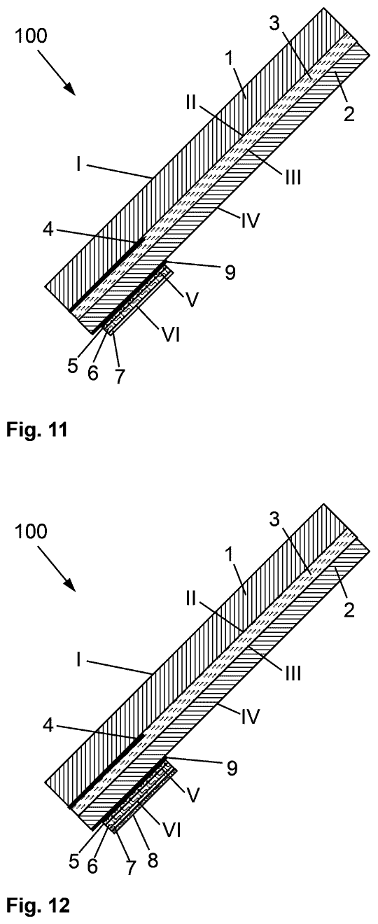

FIG. 11 shows a cross section through a further embodiment of the laminated pane according to the invention,

FIG. 12 shows a cross section through a further embodiment of the laminated pane according to the invention,

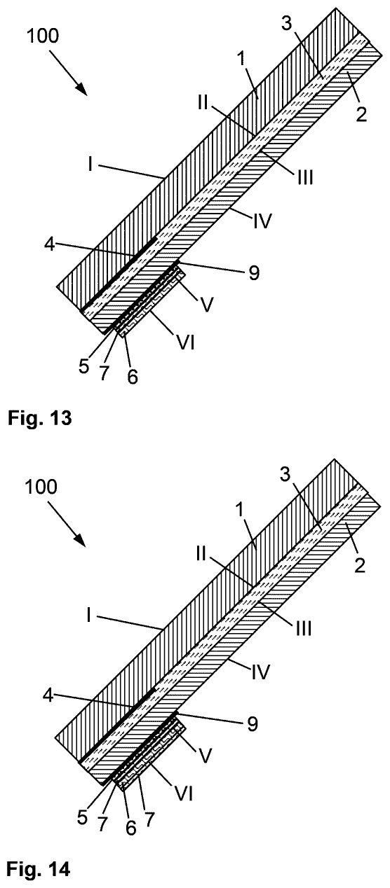

FIG. 13 shows a cross section through a further embodiment of the laminated pane according to the invention,

FIG. 14 shows a cross section through a further embodiment of the laminated pane according to the invention,

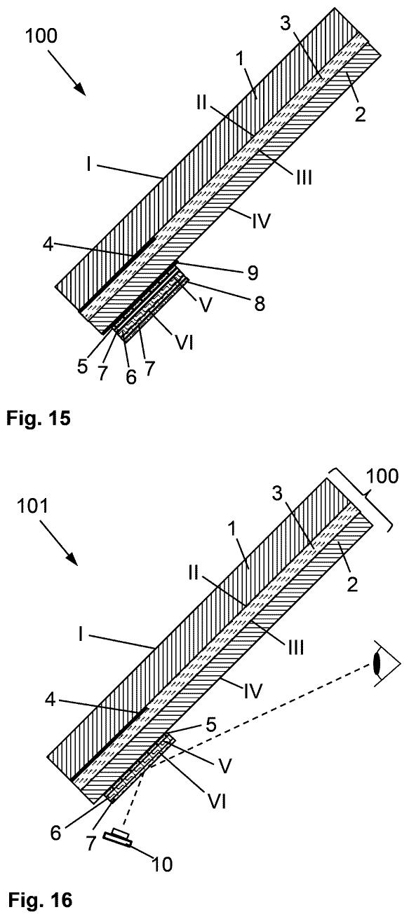

FIG. 15 shows a cross section through a further embodiment of the laminated pane according to the invention,

FIG. 16 shows a cross section through an embodiment of a projection assembly according to the invention,

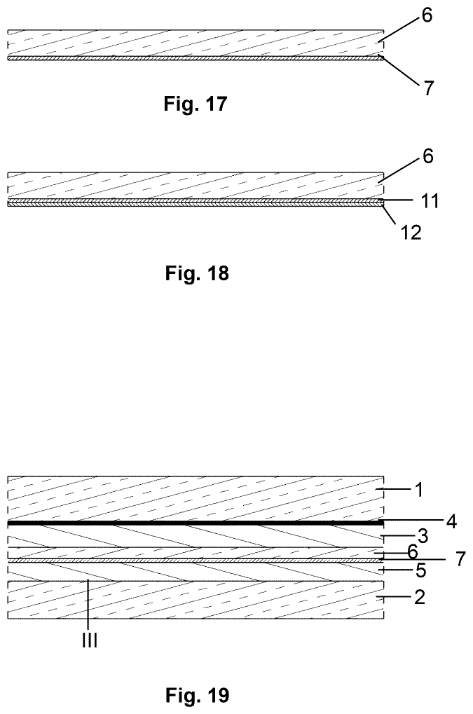

FIG. 17 shows a cross section through a coated glass pane,

FIG. 18 shows a cross section through a further coated glass pane,

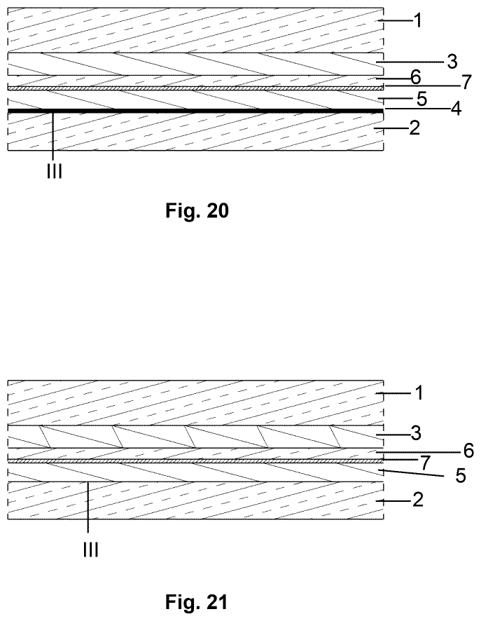

FIG. 19 shows a cross section through a further embodiment of the laminated pane according to the invention,

FIG. 20 shows a cross section through a further embodiment of the laminated pane according to the invention,

FIG. 21 shows a cross section through a further embodiment of the laminated pane according to the invention, and

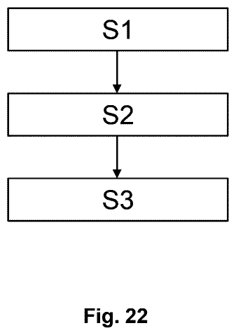

FIG. 22 shows with the aid of a flow chart an exemplary embodiment of the method according to the invention.

FIG. 1 shows a plan view of an embodiment of the laminated pane 100 according to the invention, and in FIG. 2 the cross section through the laminated pane 100 shown in FIG. 1 along the cutting line X-X′ is shown. The laminated pane 100 shown in FIGS. 1 and 2 has an upper edge O, a lower edge U and two side edges S. Furthermore, the laminated pane 100 comprises an outer pane 1 with an outer-side surface I and an interior-side surface II, an inner pane 2 with an outer-side surface III and an interior-side surface IV, a thermoplastic intermediate layer 3, a masking layer 4, an adhesive layer 5 and a glass pane 6 with an outer-side surface V and an interior-side surface VI. The thermoplastic intermediate layer 3 is arranged between the outer pane 1 and the inner pane 2, the inner pane 2 is arranged between the outer pane 1 and the glass pane 6, and the adhesive layer 5 is arranged between the inner pane 2 and the glass pane 6. The outer pane 1, the thermoplastic intermediate layer 3 and the inner pane 2 are arranged covering the entire surface of one another. The masking layer 4 is arranged between the outer pane 1 and the inner pane 2 in a region of the laminated pane 100, the areal coverage of which is smaller than the areal coverage of the laminated pane 100, i.e., the masking layer 4 does not extend over the entire surface of the laminated pane 100. In the embodiment shown in FIGS. 1 and 2, the masking layer 4 is designed as a first opaque masking print arranged on the interior-side surface Il of the outer pane 1 and is arranged only in an edge region of the laminated pane 100 bordering on the lower edge U. The glass pane 6 is arranged in a region of the laminated pane 100 which, when viewed perpendicularly through the laminated pane 100, lies entirely in the region in which the masking layer 4 is arranged. The glass pane 6 is therefore smaller in terms of its external dimensions than the inner pane 2. The outer-side surface V of the glass pane 6 is connected to the interior-side surface IV of the inner pane 2 via the adhesive layer 5. In the embodiment shown in FIG. 2, a reflective layer 7 for reflecting light is arranged on the interior-side surface VI of the glass pane 6.

The glass pane 6 is made, for example, of aluminum-silicate glass and has a thickness of 70 μm. The thermoplastic intermediate layer 3 contains PVB, for example, and has a thickness of 0.76 mm. The outer pane 1 consists, for example, of soda lime glass and is 2.1 mm thick. The inner pane 2 consists, for example, of soda lime glass and is 1.6 mm thick.

The adhesive layer 5 consists, for example, of an optically clear adhesive. Alternatively, the adhesive layer 5 consists of a thermoplastic material, such as polyvinyl butyral (PVB), and the glass pane 6 has been bonded to the inner pane 2 by lamination.

It should be understood that the laminated pane 100 can have any suitable geometric shape and/or curvature. Typically, the laminated pane 100 is a curved laminated pane. The laminated pane 100 is, for example, the windshield of a motor vehicle.

In the embodiment shown in FIGS. 1 and 2, the masking layer 4 extends between the two side edges S of the laminated pane 100 and, starting from the lower edge U of the laminated pane 100, has a width of, for example, 30 cm.

FIG. 3 shows a cross section through a further embodiment of the laminated pane 100 according to the invention. The embodiment shown in cross section in FIG. 3 (analogous to FIG. 2) differs from that shown in FIG. 2 only in that a protective layer 8 is additionally applied over the entire surface of the reflective layer 7 that is applied to the interior-side surface VI of the glass pane 6. The protective layer 8 is preferably a polymer based on polyacrylates, polyoximes, alkyd resins, polyurethanes or mixtures thereof. The protective layer 8 has, for example, a thickness of 500 nm.

FIG. 4 shows a cross section through a further embodiment of the laminated pane 100 according to the invention. The embodiment shown in cross section in FIG. 4 (analogous to FIG. 2) differs from that shown in FIG. 2 only in that the masking layer 4 is not designed as a first opaque masking print arranged on the interior-side surface Il of the outer pane 1, but as a first opaque masking print arranged on the outer-side surface III of the inner pane 2.

FIG. 5 shows a cross section through a further embodiment of the laminated pane 100 according to the invention. The embodiment shown in cross section in FIG. 5 differs from that shown in FIG. 3 only in that the masking layer 4 is not designed as a first opaque masking print arranged on the interior-side surface II of the outer pane 1, but instead as a first opaque masking print arranged on the outer-side surface III of the inner pane 2.

FIG. 6 shows a cross section through a further embodiment of the laminated pane 100 according to the invention. The embodiment shown in cross section in FIG. 6 differs from that shown in FIG. 2 only in that the masking layer 4 is not designed as a first opaque masking print arranged on the interior-side surface II of the outer pane 1, but instead is designed as an opaquely colored region of the first thermoplastic intermediate layer 3.

FIG. 7 shows a cross section through a further embodiment of the laminated pane 100 according to the invention. The embodiment shown in cross section in FIG. 7 differs from that shown in FIG. 3 only in that the masking layer 4 is not designed as a first opaque masking print arranged on the interior-side surface II of the outer pane 1, but instead is designed as an opaquely colored region of the first thermoplastic intermediate layer 3.

FIG. 8 shows a cross section through a further embodiment of the laminated pane 100 according to the invention. The embodiment shown in cross section in FIG. 8 differs from that shown in FIG. 2 only in that the reflective layer 7 is not arranged on the interior-side surface VI of the glass pane 6, but on the outer-side surface V of the glass pane 6. Optionally, in this embodiment, a protective layer can also be arranged on the reflective layer 7 directly adjacent to the adhesive layer 5.

FIG. 9 shows a cross section through a further embodiment of the laminated pane 100 according to the invention. The embodiment shown in cross section in FIG. 9 differs from that shown in FIG. 2 only in that in addition to the reflective layer 7 arranged on the interior-side surface VI of the glass pane 6, a reflective layer 7 is also arranged on the outer-side surface V of the glass pane 6.

FIG. 10 shows a cross section through a further embodiment of the laminated pane 100 according to the invention. The embodiment shown in cross section in FIG. 10 differs from that shown in FIG. 9 only in that a protective layer 8 is additionally applied to the reflective layer 7 that is applied to the interior-side surface VI of the glass pane 6. The protective layer 8 is preferably a polymer based on polyacrylates, polyoximes, alkyd resins, polyurethanes or mixtures thereof. The protective layer 8 has, for example, a thickness of 500 nm. Optionally, in this embodiment a further protective layer can also be arranged on the reflective layer 7 applied to the outer-side surface V of the glass pane 6 directly adjacent to the adhesive layer 5.

FIG. 11 shows a cross section through a further embodiment of the laminated pane 100 according to the invention. The embodiment shown in cross section in FIG. 11 differs from that shown in FIG. 2 only in that the laminated pane 100 additionally has a second opaque masking print 9 applied to the interior-side surface IV of the inner pane 2. The second opaque masking print 9 is, for example, designed in the shape of a frame.

FIG. 12 shows a cross section through a further embodiment of the laminated pane 100 according to the invention. The embodiment shown in cross section in FIG. 12 differs from that shown in FIG. 3 only in that the laminated pane 100 additionally has a second opaque masking print 9 applied to the interior-side surface IV of the inner pane 2. The second opaque masking print 9 is, for example, designed in the shape of a frame.

FIG. 13 shows a cross section through a further embodiment of the laminated pane 100 according to the invention. The embodiment shown in cross section in FIG. 13 differs from that shown in FIG. 8 only in that the laminated pane 100 additionally has a second opaque masking print 9 applied to the interior-side surface IV of the inner pane 2. The second opaque masking print 9 is, for example, designed in the shape of a frame.

FIG. 14 shows a cross section through a further embodiment of the laminated pane 100 according to the invention. The embodiment shown in cross section in FIG. 14 differs from that shown in FIG. 9 only in that the laminated pane 100 additionally has a second opaque masking print 9 applied to the interior-side surface IV of the inner pane 2. The second opaque masking print 9 is, for example, designed in the shape of a frame.

FIG. 15 shows a cross section through a further embodiment of the laminated pane 100 according to the invention. The embodiment shown in cross section in FIG. 15 differs from that shown in FIG. 10 only in that the laminated pane 100 additionally has a second opaque masking print 9 applied to the interior-side surface IV of the inner pane 2. The second opaque masking print 9 is, for example, designed in the shape of a frame.

FIG. 16 shows a cross section through an embodiment of the projection assembly 101 according to the invention. The projection assembly 101 shown in FIG. 16 comprises a laminated pane 100 and an imaging unit 10. The projection assembly 101 has an imaging unit 10. The imaging unit 10 serves to generate p-polarized light and/or s-polarized light (image information), which is directed onto the reflective layer 7 and is reflected by the reflective layer 7 as reflected light into the vehicle interior, where it can be perceived by a viewer, e.g., a driver. The reflective layer 7 is designed to reflect the light of the imaging unit 10. The light preferably impinges on the reflective layer 7 at an angle of incidence of 55° to 80°, in particular of 62° to 77°. The imaging unit 10 is, for example, a display, in particular an LCD display. Preferably, the imaging unit 10 serves to generate only p-polarized light, which can be seen well, in particular, with polarizing sunglasses that have an s-polarization filter.

In the following, embodiments of the coated glass pane 6 (FIGS. 17 and 18), as well as further embodiments of the laminated pane 100 according to the invention (FIG. 19 to 21) are illustrated by means of cross sections. In the further embodiments of FIG. 19 to 21 of the laminated pane 100 according to the invention, the coated glass pane 6 is arranged on the outer-side surface (side III) of the inner pane 2. These embodiments can be used comparably in the projection assembly 101 illustrated by way of example in FIG. 16.

FIG. 17 shows a cross section of an embodiment of the coated glass pane 6. The cross section is only shown in the region of the glass pane 6. The glass pane 6 is coated with a single-ply reflective layer 7. According to one embodiment, the single-ply reflective layer 7 is a dielectric layer or a silicon-based layer which, for example, contains or consists of undoped silicon or doped silicon. Doped silicon is doped, for example, with boron (B), aluminum (Al) and/or zirconium (Zr). Alternatively, the single-ply reflective layer 7 is, for example, a carbide layer made of, for example, TiC or ZrC.

FIG. 18 shows a cross section through a further embodiment of the coated glass pane 6. The cross section is only shown in the region of the glass pane 6. The glass pane 6 is coated with a two-layer reflective layer 7 (bilayer). The two-layer reflective layer 7 consists of a first layer 11 and a second layer 12. According to one embodiment, the first layer 11 consists of a material with a high optical refractive index and the second layer 12 of a material with a low optical refractive index, e.g., TiOₓ/SiOₓ. According to an alternative embodiment, the first layer 11 consists of doped silicon and the second layer 12 of a silicon compound, e.g., Si(B)/SiAlNₓ, Si(ZrAl)/SiAlOₓ, or Si(B)/SiAlOₓ.

FIG. 19 shows a cross section through a further embodiment of the laminated pane 100 according to the invention. The cross section is only shown in the region of the glass pane 6. The embodiment shown in cross section in FIG. 19 differs from that shown in FIG. 2 only in that the coated glass pane 6 is applied to the outer-side surface III of the inner pane 2. The adhesive layer 5 is located between the glass pane 6 and the inner pane 2. The reflective layer 7 is located between the glass pane 6 and the inner pane 2, i.e., is arranged on the interior-side surface VI of the glass pane 6.

FIG. 20 shows a cross section through a further embodiment of the laminated pane 100 according to the invention. The cross section is only shown in the region of the glass pane 6. The embodiment shown in cross section in FIG. 20 differs from that shown in FIG. 4 in that the coated glass pane 6 is applied to the outer-side surface III of the inner pane 2. The adhesive layer 5 is located between the glass pane 6 and the inner pane 2. The reflective layer 7 is located between the glass pane 6 and the inner pane 2, i.e., is arranged on the interior-side surface VI of the glass pane 6. In addition, the masking layer 4, which is formed as a first opaque masking print arranged on the outer-side surface III of the inner pane 2, has one or more openings, so that light from the imaging unit 10 can strike the reflective layer 7 and be reflected by it.

FIG. 21 shows a cross section through a further embodiment of the laminated pane 100 according to the invention. The cross section is only shown in the region of the glass pane 6. The embodiment shown in cross section in FIG. 21 differs from that shown in FIG. 6 only in that the coated glass pane 6 is applied to the outer-side surface III of the inner pane 2. The adhesive layer 5 is located between the glass pane 6 and the inner pane 2. The reflective layer 7 is located between the glass pane 6 and the inner pane 2, i.e., is arranged on the interior-side surface VI of the glass pane 6.

An exemplary embodiment of the method according to the invention is shown in FIG. 22 using a flow chart.

In a step S1, a composite is produced from an outer pane 1 with an outer-side surface I and an interior-side surface II, a thermoplastic intermediate layer 3 and an inner pane 2 with an outer-side surface III and an interior-side surface IV, wherein the thermoplastic intermediate layer 3 is arranged between the outer pane 1 and the inner pane 2 and a masking layer 4 is arranged in a region between the outer pane 1 and the inner pane 2.

In a step S2, a glass pane 6 is provided with an outer-side surface V and an interior-side surface VI, wherein a reflective layer 7 for reflecting light is arranged on the outer-side surface V of the glass pane 6 and/or on the interior-side surface VI of the glass pane 6.

In a step S3, the glass pane 6 is connected to the inner pane 2 of the composite via an adhesive layer 5 to form a laminated pane 100, such that the glass pane 6 is arranged in a region of the laminated pane 100 which, when viewed perpendicularly through the laminated pane 100, lies entirely within the region in which the masking layer 4 is arranged.

### Steps S1, S2 and S3 Can Be Carried out in Any Order or Simultaneously.

From the above, it follows that the invention provides an improved laminated pane with which the image of a projector is reflected and the virtual image is visually perceptible with sufficient brightness and high contrast, so that good recognizability, in particular of safety-relevant information, is reliably ensured in all weather and lighting conditions. In addition, unwanted secondary images can be avoided. In industrial series production, the laminated pane can be produced efficiently and cost-effectively, wherein the production of the laminated pane can be easily implemented in common production processes.

### LIST OF REFERENCE SIGNS

100 Laminated pane
101 Projection assembly
1 Outer pane
2 Inner pane
3 Thermoplastic intermediate layer
4 Masking layer
5 Adhesive layer
6 Glass pane
7 Reflective layer
8 Protective layer
9 Second opaque masking print
10 Imaging unit
11 First layer
12 Second layer
O Upper edge of the laminated pane 100
U Lower edge of the laminated pane 100
S Side edge of the laminated pane 100
I Outer surface of the outer pane 1
II Interior-side surface of the outer pane 1
III Outer surface of the inner pane 2
IV Interior-side surface of the inner pane 2
V Outer-side surface of the glass pane 6
VI Interior-side surface of the glass pane 6

1. A laminated pane comprising:
an outer pane with an outer-side surface and an interior-side surface,
a thermoplastic intermediate layer,
an inner pane with an outer-side surface and an interior-side surface,
at least one masking layer,
an adhesive layer,
a glass pane with an outer-side surface and an interior-side surface and a thickness of 20 μm to 500 μm,
wherein the thermoplastic intermediate layer is arranged between the outer pane and the inner pane the at least one masking layer is arranged between the outer pane and the inner pane in a region of the laminated pane, the adhesive layer is arranged between the inner pane and the glass pane, at least one reflective layer for reflecting light is arranged on the outer-side surface of the glass pane and/or on the interior-side surface of the glass pane, wherein the glass pane is arranged in a region of the laminated pane which, when viewed perpendicularly through the laminated pane, lies entirely within the region in which the at least one masking layer is arranged, and
wherein the at least one reflective layer contains or consists of
i) a dielectric layer, or
ii) a silicon-based layer, or
iii) a carbide layer.

2. The laminated pane according to claim 1, wherein the dielectric layer is a single or double layer, wherein the double layer consists of a first layer and a second layer, wherein the first layer contains or consists of an optically high-refractive material and the second layer contains or consists of an optically low-refractive material.

3. The laminated pane according to claim 2, wherein the first layer with an optically high-refractive material has a refractive index in the range of 1.9 to 2.5 and/or the second layer with an optically low-refractive material has a refractive index in the range of 1.3 to 1.6.

4. The laminated pane according to claim 3, wherein the first layer with an optically high-refractive material has a thickness in the range of 50 to 100 nm and/or the second layer with an optically low-refractive material has a thickness in the range of 100 to 200 nm.

5. The laminated pane according to claim 1, wherein the silicon-based layer is a single-ply and contains or consists of
i) non-doped silicon, or
ii) doped silicon which is doped with one or more dopants.

6. The laminated pane according to claim 1, wherein the silicon-based layer is a two-ply layer consisting of
a first layer which contains or consists of silicon doped with one or more dopants, and
a second layer containing or consisting of a silicon compound.

7. The laminated pane according to claim 5, wherein the silicon-based layer has a thickness in the range of 10 to 100 nm.

8. The laminated pane according to claim 1, wherein the carbide layer is a single-ply layer and has a layer thickness in the range of 10 to 100 nm.

9. The laminated pane according to claim 1, wherein the glass pane is applied to the interior-side surface or to the outer-side surface of the inner pane.

10. The laminated pane according to claim 1, wherein the glass pane has a thickness of 50 μm to 300 μm.

11. The laminated pane according to claim 1, wherein the at least one masking layer is formed as
i) an opaque masking print arranged on the interior surface of the outer pane and/or the outer-side surface of the inner pane, or
ii) as an opaque colored region of the thermoplastic intermediate layer.

12. The laminated pane according to claim 1, wherein the adhesive layer is a thermoplastic polymer layer or an optically clear adhesive.

13. A projection assembly comprising:
a laminated pane according to claim 1,
an imaging unit directed at the at least one reflective layer.

14. A method for producing a laminated pane according to claim 1, comprising:
a) producing a composite from an outer pane with an outer-side surface and an interior-side surface, a thermoplastic intermediate layer and an inner pane with an outer-side surface and an interior-side surface wherein the thermoplastic intermediate layer is arranged between the outer pane and the inner pane and at least one masking layer is arranged in a region between the outer pane and the inner pane;
b) providing a glass pane with an outer-side surface and an interior-side surface, wherein at least one reflection layer for reflecting light is arranged on the outer-side surface of the glass pane and/or on the interior-side surface of the glass pane;
c) joining the glass pane to the inner pane via an adhesive layer to form a laminated pane such that the glass pane is arranged in a region of the laminated pane which, when viewed perpendicularly through the laminated pane, lies entirely within the region in which the at least one masking layer is arranged.

15. A method comprising providing the laminated pane according to claim 1 as a vehicle pane in a vehicle of transport for traffic on land, in the air or on water.

16. The laminated pane according to claim 4, wherein the first layer with an optically high-refractive material has a thickness in the range of 70 to 90 nm and/or the second layer with an optically low-refractive material has a thickness in the range of 110 to 150 nm.

17. The laminated pane according to claim 6, wherein the one or more dopants of the first layer are selected from boron, aluminum and zirconium.

18. The laminated pane according to claim 7, wherein the silicon-based layer has a thickness in the range of 20 to 50 nm.

19. The laminated pane according to claim 8, wherein the carbide layer is a single-ply layer and has a layer thickness in the range of 30 to 80 nm.

20. The laminated pane according to claim 10, wherein the glass pane has a thickness of 50 μm to 100 μm.

21. The laminated pane according to claim 5, wherein the one or more dopants of the doped silicon are selected from boron, aluminum and zirconium.
